(19) United States
(12) Patent Application Publication
(10) Pub. No.: US 2020/0052391 A1
(43) Pub. Date: Feb. 13, 2020

(54) ENERGY CONSERVATION BY ANTENNA POLARIZATION

(71) Applicant: GM GLOBAL TECHNOLOGY OPERATIONS LLC, Detroit, MI (US)

(72) Inventors: Joseph Kampeas, Ramat-Gan (IL); Ofer Givati, Herzliya (IL); Igal Bilik, Rehovot (IL); Igal Kotzer, Tel-Aviv (IL)

(21) Appl. No.: 16/059,531

(22) Filed: Aug. 9, 2018

(51) Int. Cl. H01Q 1/32; H01Q 15/24; H01Q 21/24; G01S 13/93; H04B 17/318

(52) U.S. Cl. CPC H01Q 1/3233; H01Q 15/244; G01S 2013/9375; G01S 13/931; H04B 17/318; H01Q 21/245

(57) ABSTRACT

A vehicle, radar system and a method of detecting an object. The radar system includes a transmitter, a receiver and a processor. The transmitter generates a transmitted signal having a non-linear polarization. The receiver receives a received signal that is a reflection of the transmitted signal from the object. The processor adjusts a phase of the transmitted signal at the transmitter to obtain a selected power of the received signal at the receiver.

### INTRODUCTION

The subject disclosure relates to radar systems and methods for operating radar systems and, in particular, to using circular and/or elliptical polarized electromagnetic waves in a radar system in order to increase signal strength at a receiver of the radar system.

A radar system transmits electromagnetic waves into a region that includes an object and receives reflections of these electromagnetic waves. A comparison of the transmitted waves and reflected waves gives information regarding various parameters of the object, such as its range, velocity and angular location as measured by azimuth angle and/or elevation angle. Transmitter antennae and receiver antennae of the radar system tend to have polarization directions. When the transmitted electromagnetic wave is a linearly polarized wave, any differences in the direction of polarization of the transmitter antenna and the receiver antenna can reduce the strength of the received signal at the radar system. Accordingly, it is desirable to provide a method of transmitting and receiving electromagnetic waves that optimizes or maximizes a power of the received signal.

### SUMMARY

In one exemplary embodiment, a method of detecting an object is disclosed. The method includes generating a transmitted signal at a transmitter, the transmitted signal having a non-linear polarization, receiving, at a receiver, a received signal that is a reflection of the transmitted signal from the object, and adjusting a phase of the transmitted signal at the transmitter to obtain a selected power of the received signal at the receiver.

In addition to one or more of the features described herein, the transmitter includes two orthogonal linearly polarized antennae, further comprising adjusting the phase between the two orthogonal linearly polarized antennae to generate the transmitted signal. The method further includes determining a major axis of the received signal at the receiver. The method further includes adjusting the phase of the transmitted signal to maximize a power received along the major axis of the received signal at the receiver. In various embodiments, the transmitted signal is a circularly polarized signal and the received signal is an elliptically polarized signal, or the transmitted signal is an elliptically polarized signal and the received signal is an elliptically polarized signal. The method further includes iteratively adjusting the phase based on feedback from the received signal until a convergence to a maximum power intensity value occurs at the receiver.

In another exemplary embodiment, a radar system for a vehicle is disclosed. The radar system includes a transmitter, a receiver and a processor. The transmitter generates a transmitted signal having a non-linear polarization. The receiver receives a received signal that is a reflection of the transmitted signal from the object. The processor adjusts a phase of the transmitted signal at the transmitter to obtain a selected power of the received signal at the receiver.

In addition to one or more of the features described herein, the transmitter includes two orthogonal linearly polarized antennae and the processor is further configured to adjust the phase between the two orthogonal linearly polarized antennae to generate the transmitted signal. The processor is further configured to determine a major axis of the received signal at the receiver. The processor is further configured to adjust the phase to generate the transmitted signal to maximize a power received along the major axis of the received signal at the receiver. In various embodiments, the transmitted signal is a circularly polarized signal and the received signal is an elliptically polarized signal, or the transmitted signal is an elliptically polarized signal and the received signal is an elliptically polarized signal. The processor iteratively adjusts the phase based on feedback from the received signal until a convergence to a maximum power intensity value occurs at the receiver.

In yet another exemplary embodiment, a vehicle is disclosed. The vehicle includes a radar system and a processor. The radar system includes a transmitter and a receiver. The transmitter generates a transmitted signal having a non-linear polarization. The receiver receives a received signal that is a reflection of the transmitted signal from the object. The processor adjusts a phase of the transmitted signal at the transmitter to obtain a selected power of the received signal at the receiver.

In addition to one or more of the features described herein, the transmitter includes two orthogonal linearly polarized antennae and the processor is further configured to adjust the phase between the two orthogonal linearly polarized antennae to generate the transmitted signal. The processor is further configured to determine a major axis of the received signal at the receiver and adjust the phase of the transmitted signal to maximize a power received along the major axis of the received signal at the receiver. In various embodiments, the transmitted signal is a circularly polarized signal and the received signal is an elliptically polarized signal, or the transmitted signal is an elliptically polarized signal and the received signal is an elliptically polarized signal. The processor iteratively adjusts the phase based on feedback from the received signal until a convergence to a maximum power intensity value occurs at the receiver.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle with an associated trajectory planning system in accordance with various embodiments;

FIG. 2 shows a schematic diagram of a radar system suitable for use with the vehicle of FIG. 1;

FIG. 3 shows details of an illustrative transmitter of the radar system of FIG. 2;

FIG. 4 shows an electromagnetic waveform that can be generated and transmitted using the transmitter of FIGS. 2 and 3; and

FIG. 5 shows a flowchart detailing a method of detecting an object that includes energy conservation by adjusting an antenna's polarization.

### DETAILED DESCRIPTION

The following description is merely exemplary in nature and is not intended to limit the present disclosure, its application or uses. It should be understood that throughout the drawings, corresponding reference numerals indicate like or corresponding parts and features.

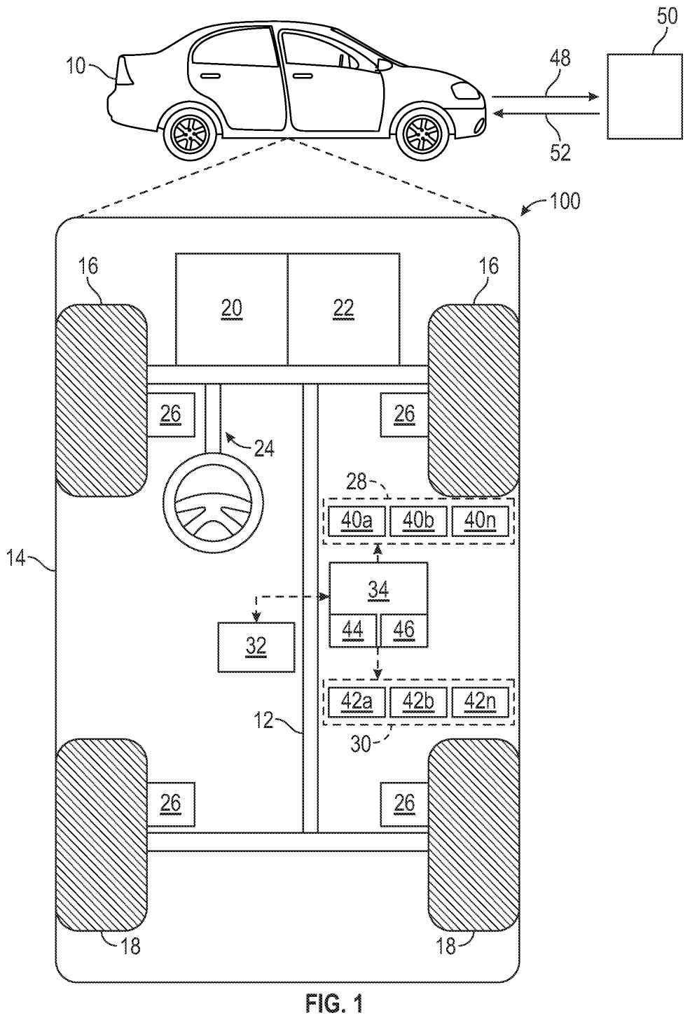

In accordance with an exemplary embodiment, FIG. 1 shows a vehicle 10 with an associated trajectory planning system depicted at 100 in accordance with various embodiments. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle and the trajectory planning system 100 is incorporated therein. The vehicle 10 can, for example, be automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20, a transmission system 22, a steering system 24, a brake system 26, a sensor system 28, an actuator system 30, at least one data storage device 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the vehicle wheels 16 and 18. While depicted as including a steering wheel for illustrative purposes, in some embodiments contemplated within the scope of the present disclosure, the steering system 24 may not include a steering wheel.

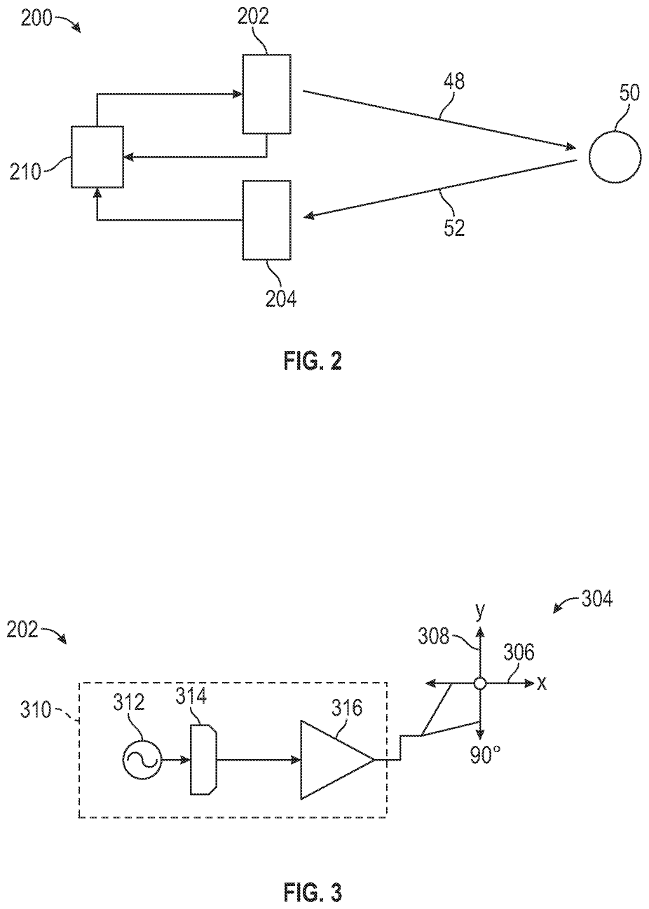

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In various embodiments, the vehicle 10 includes a radar system 200, FIG. 2. The radar system 200 includes one or more radar transducers located at various locations along the vehicle 10. In operation, a radar transducer sends out electromagnetic pulses 48 that are reflected back at the vehicle 10 by the object 50 in the form of reflected pulses 52. The reflected pulses 52 are received at the transducers in order to determine parameters such as range, angular location and Doppler frequency (velocity) of the object 50.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The trajectory planning system 100 navigates the autonomous vehicle 10 based on a determination of objects and/their locations within the environment of the vehicle. In various embodiments the controller 34 performs calculations to determine the presence and/or location of an object in the vehicle's environment from the reflections 52, which includes a consideration of a phase of the reflections as they are received at the radar system 200, FIG. 2. Upon determining various parameters of the object, such as range, azimuth, elevation, velocity, etc., from the plurality of detections, the controller 34 can operate the one or more actuator devices 42a-42n, the propulsion system 20, transmission system 22, steering system 24 and/or brake 26 in order to navigate the vehicle 10 with respect to the object 50. In various embodiments, the controller 34 navigates the vehicle 10 so as to avoid contact with the object 50. In various embodiments, the pulses can be circularly polarized, elliptically polarized or linearly polarized.

FIG. 2 shows a schematic diagram of a radar system 200 suitable for use with the vehicle 10 of FIG. 1. The radar system 200 includes a transmitter 202, a receiver 204 and a processor 210. The transmitter 202 transmits a test signal 48 generated by a waveform generator 312, FIG. 3. A reflected signal 52 occurs when the test signal 48 interacts with the object 50. The receiver 204 receives the reflected signal 52. Processor 210 determines differences between the reflected signal 52 and the test signal 48 in order to determine various parameters of the object 50. Additionally, processor 210 determines a power intensity of the reflected signal 52 at the receiver 204 and adjusts a parameter of the test signal 48 in order to increase a power intensity at the receiver 204. In various embodiments, adjusting the parameter includes adjusting a phase parameter of the test signal. The adjustment to the parameter is provided to the transmitter 202 and the transmitter 202 adjusts the parameter accordingly.

FIG. 3 shows details of an illustrative transmitter 202 of the radar system 200 of FIG. 2. The transmitter 202 includes an antenna system 304 and an electronics system 310. The antenna system 304 includes a first antenna 306 and a second antenna 308 which are orthogonal to each other. For illustrative purposes, the first antenna 306 is aligned along an x-axis and the second antenna 308 is aligned along a y-axis. As a result, the first antenna 306 generates signals having a polarization vector pointing along the x-axis and the second antenna 308 generates signals having a polarization vector pointing along the y-axis.

The electronics system 310 includes waveform generator 312, a digital-to-analog converter (DAC) 314 and an amplifier 316. The waveform generator 312 generates a signal for transmission by the antenna system 304. The signal includes a first signal waveform for the first antenna 306 and a second signal waveform for the second antenna 308. The digital-to-analog converter (DAC) 314 converts the first and second waveforms into first and second analog waveforms. The first and second digitized waveforms are sent to an amplifier 316 for amplification. The first waveform is sent as first signal component to the first antenna 306 and the second waveform is sent as second signal component to the second antenna 308. By separating the signal waveform into a first signal component and a second signal component, the electronics system 310 controls the operation of the first antenna 306 and the second antenna 308 and, in particular, controls the phase δ between the first signal component and the second signal component. Specifically, the phase δ can be controlled to generate one of: a linearly polarized wave, a circularly polarized (CP) wave and an elliptically polarized (EP) wave.

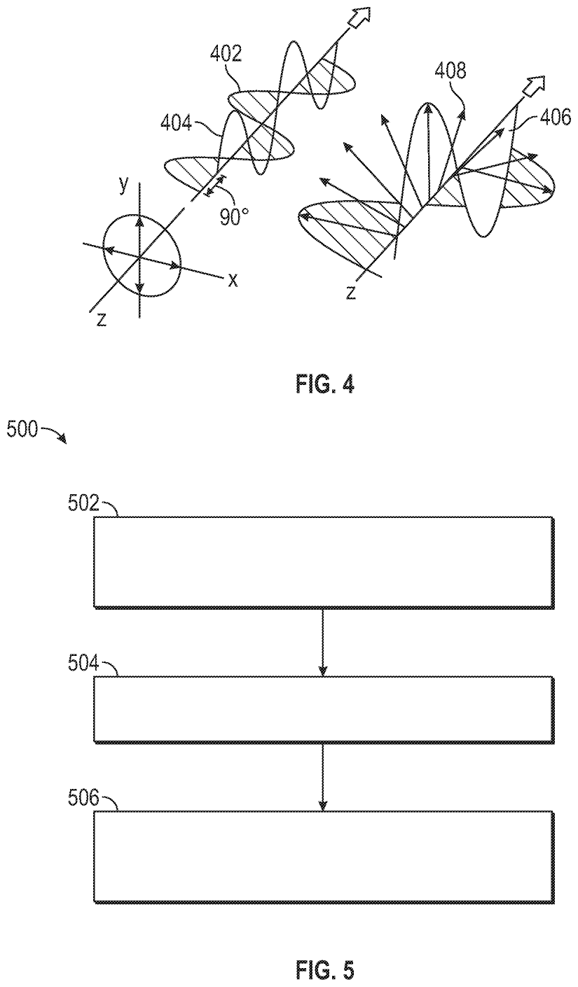

FIG. 4 shows an electromagnetic waveform that can be generated and transmitted using the transmitter 202 of FIGS. 2 and 3. The electromagnetic wave propagates along a z-direction. The first signal component 402 (along the x-axis) is separated in phase from the second single component 404 (along the y-axis) by a phase of 90°. The superposition of the first signal component 402 with the second signal component 404 results in a single signal 406 that has a polarization vector 408 that revolves around the z-axis. This revolution of the polarization vector 408 is indicative of circular or elliptical polarization.

Eq. (1) shows a generalized equation for the signal 406 propagating along a z-axis as transmitted from the antenna system of FIG. 3:

$$E = a cos ( 2 π f ( t - \frac{z}{c} ) ) \hat{x} + b sin ( 2 π f ( t - \frac{z}{c} ) + δ ) \hat{y} \qquad Eq . ( 1 )$$

where E is the electric field, a and b are respective amplitudes of the first component and second component, f is the frequency of the signal and δ determines the relative phase between the first signal component 402 and the second signal component 404. When δ=+90°, the electric field undergoes a counter-clockwise rotation and when δ=−90°, the electric field undergoes a clockwise rotation. Alternating between these two phase values changes the direction of circulation of the polarization vector. When a=b, the amplitudes of the components are equal, thus leading to a circular polarization, either clockwise of counter-clockwise. When a and b are unequal, the electric field has an elliptical polarization, either clockwise of counter-clockwise.

When a transmitted right circularly polarized (RCP) wave is reflected off of a target that is a conductor, the reflection has an opposite polarization as the transmitted wave. When the target is not a conductor, the reflected wave still has an opposite polarization as the transmitted wave. However, the reflected wave now has an elliptical polarization. Thus, in various embodiments, when using circularly or elliptically polarized waves at the transmitter, reflected waves having an elliptically polarized E-field is received at the receiver.

The elliptical polarization is defined by its “axial ratio” which is a ratio of the amplitudes along the major axis and minor axis of the elliptically polarized wave (e.g., b/a). The major axis is an axis having a greatest power intensity and the minor axis is an axis having a smallest power intensity. In various embodiments, processor 210 determines the ratio of the amplitudes and determines an orientation of the major axis and the minor axis of the elliptically-polarized reflected wave. The processor 210 determines a phase δ for the transmitted wave or test signal in order to produce a reflection aligned along the major axis, thereby increasing a strength of the signal.

Observing the transmitted signal of FIG. 4, the phase between first signal component 402 and second signal component 404 can be adjusted within a range from 0 to 2π. Eq. (3) describes a relation between two sinusoidal waveforms separated by a phase δ(t):

sin(ωt₁+δ(t))=sin(ωt₀) Eq. (3)

Using the relation t₁=t₀+Δₜ, then

sin(ω(t₀+Δₜ)+δ(t))=sin(ωt₀) Eq. (4)

which is true when:

δ(t)=−ωΔₜ+2πk Eq. (5)

Thus phase δ(t) can be adjusted at the transmitter using the relation shown in Eq. (5). The phase can be selected in order to focus the received energy on the major axis at the receiver. In various embodiments, the processor can iteratively adjust the phase δ(t) between the first signal component 402 and the second signal component 404 several times based on receiver feedback until a convergence to a maximum power intensity value occurs at the receiver.

FIG. 5 shows a flowchart detailing a method 500 of detecting an object that includes energy conservation by adjusting and antenna's polarization. In box 502, a transmitter generates a transmitted signal having a polarization other than linear polarization, e.g., circularly polarized, elliptically polarized, etc. In box 504, a receiver receives a signal (“received signal”) that is a reflection of the transmitted signal from the object. In box 506, the phase of the transmitted signal is adjusted in order to obtain a selected power for the received signal at the receiver.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of detecting an object, comprising:
generating a transmitted signal at a transmitter, the transmitted signal having a non-linear polarization;
receiving, at a receiver, a received signal that is a reflection of the transmitted signal from the object; and
adjusting a phase of the transmitted signal at the transmitter to obtain a selected power of the received signal at the receiver.

2. The method of claim 1, wherein the transmitter includes two orthogonal linearly polarized antennae, further comprising adjusting the phase between the two orthogonal linearly polarized antennae to generate the transmitted signal.

3. The method of claim 2, further comprising determining a major axis of the received signal at the receiver.

4. The method of claim 3, further comprising adjusting the phase of the transmitted signal to maximize a power received along the major axis of the received signal at the receiver.

5. The method of claim 1, wherein the transmitted signal is a circularly polarized signal and the received signal is an elliptically polarized signal.

6. The method of claim 1, wherein the transmitted signal is an elliptically polarized signal and the received signal is an elliptically polarized signal.

7. The method of claim 1, further comprising iteratively adjusting the phase based on feedback from the received signal until a convergence to a maximum power intensity value occurs at the receiver.

8. A radar system for a vehicle, comprising:
a transmitter for generating a transmitted signal having a non-linear polarization; and
a receiver for receiving a received signal that is a reflection of the transmitted signal from the object; and
a processor configured to adjust a phase of the transmitted signal at the transmitter to obtain a selected power of the received signal at the receiver.

9. The radar system of claim 8, wherein the transmitter includes two orthogonal linearly polarized antennae and the processor is further configured to adjust the phase between the two orthogonal linearly polarized antennae to generate the transmitted signal.

10. The radar system of claim 9, wherein the processor is further configured to determine a major axis of the received signal at the receiver.

11. The radar system of claim 10, wherein the processor is further configured to adjust the phase to generate the transmitted signal to maximize a power received along the major axis of the received signal at the receiver.

12. The radar system of claim 8, wherein the transmitted signal is a circularly polarized signal and the received signal is an elliptically polarized signal.

13. The radar system of claim 8, wherein the transmitted signal is an elliptically polarized signal and the received signal is an elliptically polarized signal.

14. The radar system of claim 8, wherein the processor iteratively adjusts the phase based on feedback from the received signal until a convergence to a maximum power intensity value occurs at the receiver.

15. A vehicle, comprising:
a radar system including:
a transmitter for generating a transmitted signal having a non-linear polarization, and
a receiver for receiving a received signal that is a reflection of the transmitted signal from the object; and
a processor configured to adjust a phase of the transmitted signal at the transmitter to obtain a selected power of the received signal at the receiver.

16. The vehicle of claim 15, wherein the transmitter includes two orthogonal linearly polarized antennae and the processor is further configured to adjust the phase between the two orthogonal linearly polarized antennae to generate the transmitted signal.

17. The radar system of claim 16, wherein the processor is further configured to determine a major axis of the received signal at the receiver and adjust the phase of the transmitted signal to maximize a power received along the major axis of the received signal at the receiver.

18. The radar system of claim 15, wherein the transmitted signal is a circularly polarized signal and the received signal is an elliptically polarized signal.

19. The radar system of claim 15, wherein the transmitted signal is an elliptically polarized signal and the received signal is an elliptically polarized signal.

20. The radar system of claim 15, wherein the processor iteratively adjusts the phase based on feedback from the received signal until a convergence to a maximum power intensity value occurs at the receiver.
